(19) United States
(12) Patent Application Publication
(10) Pub. No.: US 2006/0126860 A1
(43) Pub. Date: Jun. 15, 2006

(54) Flexible lighting and sound configuration

(76) Inventors: Leon R. Sievers, Aliso Viejo, CA (US); Larry D. Brown, San Clemente, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/292,371

(22) Filed: Dec. 1, 2005

Related U.S. Application Data
(60) Provisional application No. 60/632,161, filed on Dec. 1, 2004.

(51) Int. Cl. H04B 3/00; H04B 3/54

(52) U.S. Cl. 381/77; 307/1

(57) ABSTRACT

An audio output device (101) is configured to transmit an audio signal to an external power amplifier (107). The transmission of the audio signal can be accomplished by means of a wireless transmitter (401) or standard audio cable (103). The power amplifier (107), a low voltage power supply (111), and in certain embodiments a wireless receiver (109) are commonly housed in a weatherproof enclosure. In one embodiment of the invention, the amplified audio signal and low voltage power provided by the low voltage power supply (111) are transmitted by means of a common cable to a lighting and sound unit (115).

### PRIORITY CLAIM

This application claims the benefit under 35 U.S.C. § 119(e) of U.S. Provisional Patent Application Ser. No. 60/632,161, filed Dec. 1, 2004, entitled “Loudspeaker System with Integrated Lighting Fixture and Common Power Supply,” the entirety of which is incorporated herein by reference.

### TECHNICAL FIELD

The present invention relates generally to the field of lighting and sound systems, and more specifically to a flexible configuration of speakers that include a lighting source.

### BACKGROUND ART

Loudspeakers are commonplace and well known. Indeed, the use of such loudspeakers in an outdoor environment has grown in popularity as outdoor spaces are increasingly used as an extension of living space. For both functional and decorative purposes, outdoor loundspeakers are designed to appear as rocks, planters, pedestals, furniture and even animals which blend into landscaping. Often, such outdoor loundspeakers are placed along pathways, driveways, sidewalks, patios, plant beds, pools and spas. The loundspeakers are commonly designed to reproduce background music, radio and television broadcasts, nature sounds and, in commercial applications, programmed audio material such as advertising, public addresses, and security and safety announcements.

As is the case in indoor sound systems, outdoor loudspeakers are often combined in order to create an integrated outdoor sound system. Such outdoor sound systems typically comprise a plurality of speakers connected by speaker wires to a stereo system, which are strategically placed to maximize their utility. It is difficult and often expensive to wire the outdoor speaker system, and sometimes such wiring requires significant alterations and damage to the interior of a home. Typically, the speaker wires are buried below the surface of the ground in such a manner that each outdoor speaker is electrically connected to the speaker output of the indoor stereo system.

In addition to loudspeakers and outdoor sound systems, there exists a number of outdoor lighting devices that use a variety of embodiments and power sources. Typically, power sources employed comprise a low-voltage power source that is provided to each of the individual outdoor lighting devices by means of wiring buried below the surface of the ground, or sometimes simply placed on the surface of the ground.

Recently, combined lighting and sound systems have begun to emerge in various embodiments. In many cases, such systems cannot be configured to use a commonly housed lighting and sound unit. Rather, separate sound and lighting units are used. Further, the utility of outdoor lighting and sound systems has been vastly limited as a result of the lack of an efficient and effectively integrated power supply. In existing systems, the power sources utilized are often delivered from different locations and from different power sources. In some cases, the power source, such as a battery, is provided within the lighting or sound unit itself and not from a central, integrated source.

Although their has been a substantial increase in the types of outdoor lighting and sound systems in light of strong consumer demand for such systems, the current lighting and sound systems available today contain a number of features that limit their utility and market acceptance. What is needed is a fully integrated and flexible outdoor lighting and sound system that permits the use of common systems to reduce the costs of installation, permits the wireless transmission of an audio signal from an existing audio output device which eliminates the need to alter any interior structures in order to install the system, and that can be powered by a single, centralized power supply. It would also be desirable for the lighting and sound units to be integrated, and constructed to enhance the overall quality of the lighting and sound.

### DISCLOSURE OF INVENTION

A flexible system and method to transmit of both light and sound. More specifically, the lighting and sound system (115) comprises one or more audio output devices (101) that are configured to transmit an audio signal to an external power amplifier (107). The transmission of the audio signal can be accomplished by means of a wireless transmitter (401) or standard audio cable (103). The power amplifier (107), the low voltage power supply (111), and in certain embodiments the wireless receiver (109) are commonly housed in a weatherproof enclosure. In one embodiment of the invention, the amplified audio signal and low voltage power provided by a low voltage power supply (111) is transmitted by means of a common cable to a lighting and sound unit (115).

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use or application should be considered apparent as an alternative embodiment of the present invention.

### BRIEF DESCRIPTION OF THE DRAWINGS

These and other more detailed and specific objects and features of the present invention are more fully disclosed in the following specification, reference being to the accompanying drawings, in which:

FIG. 1 is a high level block diagram illustrating an overview of a sound and lighting system, according to one embodiment of the present invention.

FIG. 2 is a front view of a receiver and audio amplifier front panel controls located within a weatherproof outdoor enclosure, according to one embodiment of the present invention.

FIG. 3 is a rear view of the connections of the common power supply and audio amplifier, and the power supply and audio amplifier, contained within the weatherproof outdoor enclosure, according to one embodiment of the present invention.

FIG. 4 is a perspective view of a wireless transmitter and antenna assembly which transmits the audio signal in the embodiment illustrated in FIG. 2.

FIG. 5 is a perspective view of sound and lighting unit, according to one embodiment of the present invention.

FIG. 6 is a block diagram illustrating another embodiment of the sound and lighting system.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

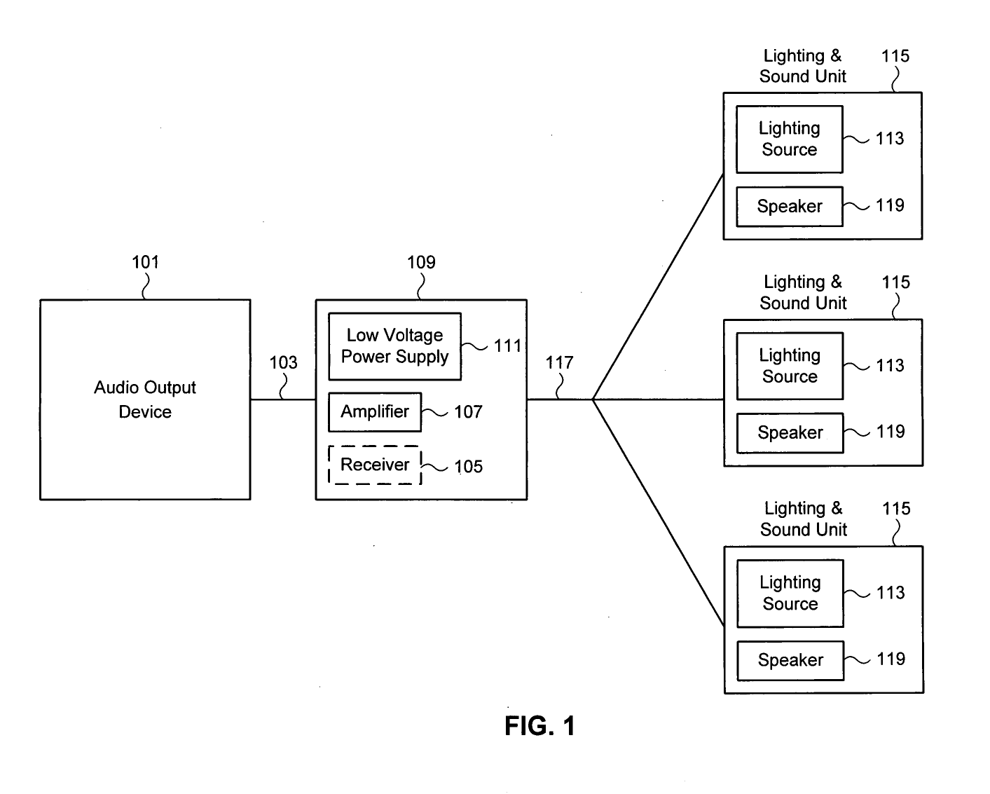

FIG. 1 is a high level block diagram illustrating an overview of an embodiment of the present invention, whereby an audio output device 101 is configured to transmit an audio signal by means of conventional audio cable 103 or wirelessly to a receiver 105 and power amplifier 107. It is to be understood that the audio output device 101 can comprise any device capable of outputting an audio signal such as a compact disk player, a radio receiver, an audio tape player, a video tape player, a digital audio disk player, a digital video disk player, an electronic musical instrument, a computer, a television, a musical instrument digital interface, or a record player. Indeed, in one embodiment, more than one audio output device 101 can be configured to transmit an audio signal by means of conventional audio cable 103 or wirelessly to a receiver 105 and power amplifier 107.

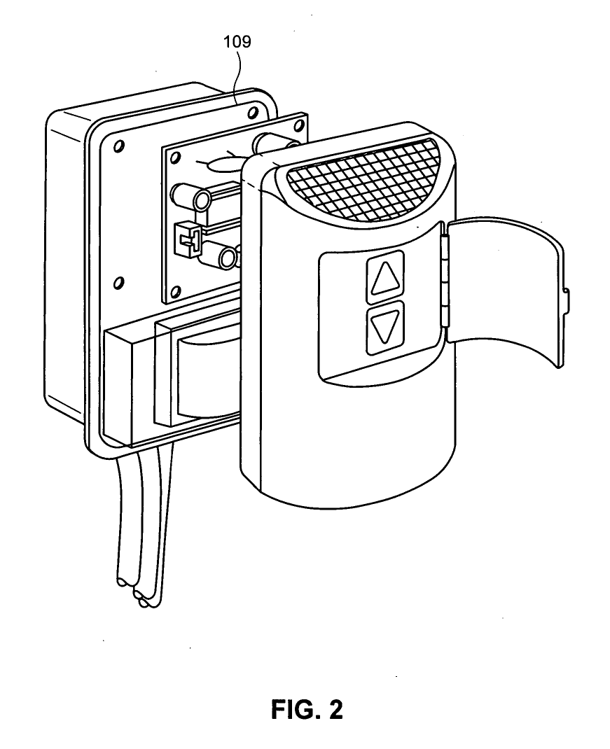

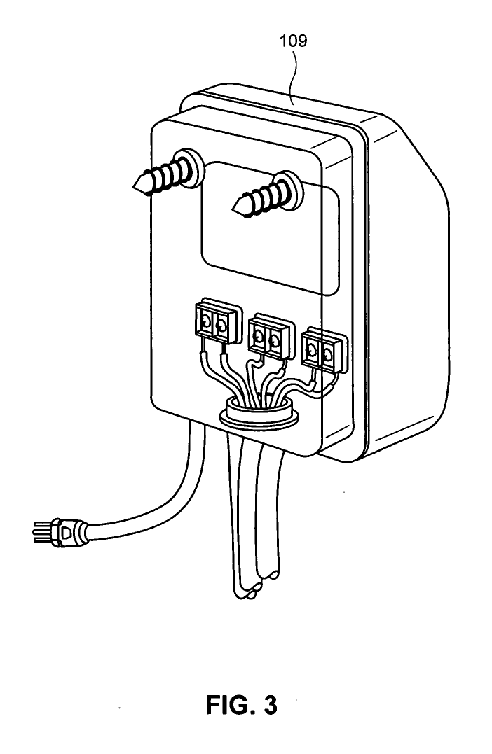

The audio signal from the audio output device 101 is delivered by means of standard audio cable 103 or wirelessly to the receiver 105 and power amplifier 107. In one embodiment, the receiver 105 and power amplifier 107 are housed within a common weatherproof outdoor enclosure 109. A front view of one such embodiment of a commonly housed receiver 105 and power amplifier 107 is show at FIG. 2. FIG. 3 illustrates a rear view of one embodiment of the commonly housed receiver 105 and power amplifier 107. As illustrated by FIG. 1, in one embodiment, a low voltage power supply 111 and power amplifier 107 can be integrated into a single unit 109. Of course, in other embodiments, a low voltage power supply 111 and power amplifier 107 are housed in separate units. The receiver 105 can also be housed separately.

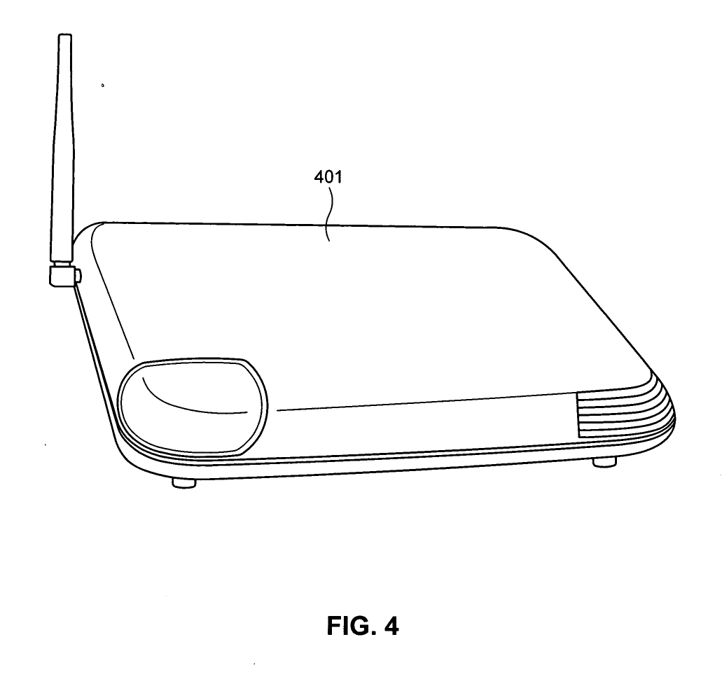

FIG. 4 is an illustration of a wireless transmitter 401, which is used in one embodiment of this invention, which is configured to receive an audio signal from the audio output device 101 and to transmit the audio signal wirelessly to a receiver 105 and power amplifier 107. The wireless transmitter 401 can be coupled to the audio output device 101 in a manner that will be readily apparent to one of ordinary skill in the relevant art.

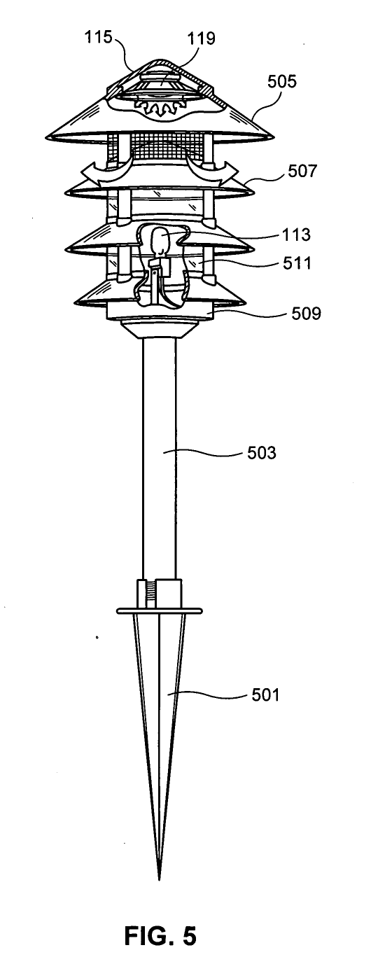

As shown in FIG. 1, the power amplifier 107 and low voltage power supply 111 are coupled to at least one shared lighting and sound unit 115. In one embodiment, the power amplifier 107 and low voltage power supply 111 are wired to at least one of the lighting and sound units 111 by means of a common cable assembly 117, which can be buried below the surface of the ground. Each shared lighting and sound unit 115 contains at least one lighting source 113 configured to transmit light and at least one speaker 119 configured to transmit sound. In one embodiment, at least one of the lighting and sound units 115 is configured to provide for the independent operation of the lighting source 113 and speaker 119. In one embodiment, one or more of the lighting and sound units 115 is at least partially powered by one or more integrated power sources. For example, the integrated power source can include a solar power unit, a battery, or a fossil fuel powered engine. The lighting and sound units 115 can be powered by differing combinations of one or more integrated power sources. The shared lighting and sound unit 115 can be integrated into a variety of structures such as a stake as illustrated in FIG. 5, a simulated rock, a lamp, a piece of furniture, a vase, an urn, a simulated potted plant, a lawn ornament, and outdoor fixture, or an outdoor appliance. Any combination of shared lighting and sound units 115 can be utilized, and such units 115 can be configured for either indoor or outdoor use, or both.

FIG. 5 is a perspective view of a lighting and sound unit 115, which includes an integrated low voltage lighting source 113 and speaker 119 according to one embodiment of the present invention. In one embodiment of the present invention, and as noted above, the shared lighting and sound unit 115 is anchored by means of a stake 501 and elevated above the surface of the ground by means a support mast 503. The shared lighting and sound unit 115 can contain a domed surface 505 as illustrated that serves as an acoustical chamber for the speaker 119. The cavity created by the domed surface 505 can also serve, in certain embodiments, as a protective housing for a speaker 119. The domed speaker enclosure 505 can be configured with a radius to accommodate a speaker 119 such that the domed speaker enclosure 505 reduces cancellation of the rear wave emanating from the speaker 119. This allows the speakers 119 to be operated at sufficient volume to accommodate acoustical material, as required, and enhances and maximizes speaker performance. In the embodiment of the sound and lighting unit 115 illustrated at FIG. 5, the speaker 119 contains an audio phase plug 507 such that the radius of the dome 505 is shaped in a manner to cause direct sound emanating from the speaker 119 to be reflected outward from the speaker 119. The audio phase plug 507 can also be configured to protect the lighting fixture 509 from the environment. The lighting and sound unit 115 in the embodiment illustrated at FIG. 5 contains a protective lens 511 that encases the lighting source 113, which can serve to protect the lighting source 113 and the lighting fixture 509 from the environment. The protective lens 511 can be constructed from either clear or colored plastic, glass, or other suitable material as will be apparent to those of ordinary skill in the relevant art. In one embodiment, the protective lens 511 is constructed to enable the distribution of light in a 360 degree pattern from the lighting source 601. In other embodiments, the protective lens 511 is constructed to focus the distribution of light in a pattern of less than 360 degrees.

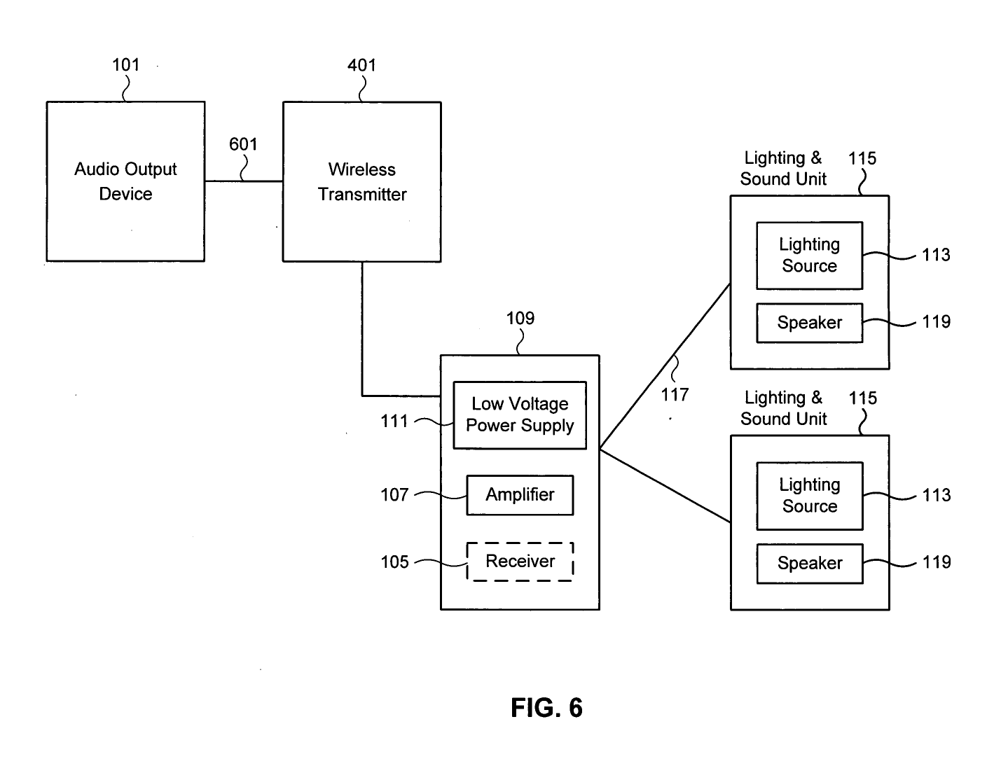

FIG. 6 is a block diagram illustrating another embodiment of the present invention. In this embodiment, the audio output device 101 is connected by means of a cable 601 to a wireless transmitter 401 that is further configured to wirelessly transmit the audio signal from the wireless transmitter 401 to a receiver 105 and power amplifier 107. The wireless transmitter 401 and receiver 105 are configured to enable the audio signal to be transmitted from an indoor location to either an indoor or an outdoor location. In one embodiment, the receiver 105, power amplifier 107, and low voltage power supply 111 share a common housing 109 that is weatherproof and is configured so that it can be mounted to the exterior of a house or other outside structure. In other embodiments, the receiver 105, power amplifier 107 and low voltage power supply 111 are not housed in a common structure. The receiver 105 is configured to receive the wireless audio signal from the wireless transmitter 401, and the power amplifier 107 to amplify the wireless audio signal and transmit it by means of a cable 117 to at least one speaker 119 of the shared lighting and sound unit 115. In one embodiment, the low voltage power supply 111 and amplifier 107 is connected to at least one shared lighting and sound unit 115, such as the one described above and illustrated at FIG. 5, by way of a common cable assembly 117 that can be buried under the surface of the ground.

The above description is included to illustrate the operation of certain embodiments and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. A sound and lighting system comprising:
a) an audio output device configured to transmit an audio signal;
b) a power amplifier configured to receive and amplify the audio signal and transmit the amplified audio signal to at least one speaker of at last one shared lighting and sound unit, the power amplifier being communicatively coupled to the audio output device;
c) at least one low voltage power supply configured to transmit a power signal to at least one lighting source of at least one shared lighting and sound unit, the low voltage power supply being communicatively coupled to at least one lighting source of at least one shared lighting and sound unit.
d) a plurality of shared lighting and sound units each containing at least one lighting source configured to transmit light and at least one speaker configured to transmit sound, each shared unit being communicatively coupled to a cable; and
e) at least one cable assembly configured to transmit at least the amplified audio signal, the cable assembly being communicatively coupled to the power amplifier and to at least one of the plurality of shared lighting and sound units.

2. The system of claim 1 wherein the audio output device is further configured to transmit a wireless audio signal.

3. The system of claim 1 wherein the audio output device is at least one audio output device from a group consisting of:
a compact disk player;
a radio receiver;
an audio tape player;
a video tape player;
a digital audio disk player;
a digital video disk player;
an electronic musical instrument;
a computer;
a television;
a musical instrument digital interface; and
a record player.

4. The system of claim 3 wherein the audio output device consists of at least two devices from the group.

5. The system of claim 1 wherein the power amplifier is further configured to receive a wireless signal from the audio output device.

6. The system of claim 1 wherein at least the power amplifier is housed in a weather proof enclosure.

7. The system of claim 1 wherein the power amplifier and the low voltage power supply are integrated into a single unit configured to transmit both the amplified audio to at least one speaker of at least one shared lighting and sound unit and the power signal to at least one lighting source of at least one shared lighting and sound unit.

8. The system of claim 1 wherein at least one of the lighting and sound units is further configured to provide independent operation of the lighting source and the speaker.

9. The system of claim 1 wherein at least one of the lighting and sound units is at least partially powered by at least one integrated power source of a group consisting of:
a solar power source;
at least one battery; and
a fossil fuel powered engine.

10. The system of claim 1 wherein at least one light and sound unit further comprises a domed surface integrated with the speaker and configured to serve as an acoustical chamber for the speaker.

11. The system of claim 10 wherein the domed surface is configured to reduce distortion of the audio signal.

12. The system of claim 1 wherein at least one of the shared lighting and sound unit further comprises a weather proof enclosure.

13. The system of claim 1 wherein at least one of the shared lighting and sound units is integrated with a housing from a group consisting of:
a simulated rock;
a lamp;
a piece of furniture;
a vase;
an urn;
a simulated potted plant;
a lawn ornament;
an outdoor fixture; and
an outdoor appliance.

14. The system of claim 1 wherein at least one of the shared lighting and sound units is further configured for indoor use.

15. The system of claim 1 wherein the cable assembly is wired from at least one shared lighting and sound unit to at least one other shared lighting and sound unit.

16. The system of claim 1 wherein the cable assembly comprises more than one cable.

17. The system of claim 1 wherein the cable assembly is configured for underground installation and use.

18. A method of providing sound and lighting, the method comprising the following components:
a) an audio output device configured to transmit an audio signal;
b) a power amplifier configured to receive and amplify the audio signal and transmit the amplified audio signal to at least one speaker of at least one shared lighting and sound unit, the power amplifier being communicatively coupled to the audio output device;
c) at least one low voltage power supply configured to transmit a power signal to at least one lighting source of at least one shared lighting and sound unit, the low voltage power supply being communicatively coupled to at least one lighting source of at least one shared lighting and sound unit.
d) a plurality of shared lighting and sound units each containing at least one lighting source configured to transmit light and at least one speaker configured to transmit sound, each shared unit being communicatively coupled to a cable; and
e) at least one cable assembly configured to transmit at least the amplified audio signal, the cable assembly being communicatively coupled to the power amplifier and to at least one of the plurality of shared lighting and sound units.

19. A sound and lighting system comprising:
a) an audio output device configured to wirelessly transmit an audio signal from an indoor location;
b) a power amplifier configured to wirelessly receive the audio signal, to amplify the audio signal and to transmit the amplified audio signal to at least one speaker of at least one shared lighting and sound unit, the power amplifier being wirelessly communicatively coupled to the audio output device;
c) at least one low voltage power supply configured to provide a power signal to at least one lighting source of at least one shared lighting and sound unit, the low voltage power supply being wired to at least one lighting source of a shared lighting and sound unit.
d) a plurality of shared lighting and sound units each being mounted on a stake and each containing at least one lighting source configured to transmit light and at least one speaker configured to transmit sound, each shared lighting and sound unit being wired to a cable; and
e) at least one cable assembly configured to transmit at least the amplified audio signal and power signal, the cable assembly being wired to the power amplifier, to the low voltage power supply and to at least one of the plurality of shared lighting and sound units.

20. A method of providing sound and lighting, the method comprising providing the following components:
a) an audio output device configured to wirelessly transmit an audio signal from an indoor location;
b) a power amplifier configured to wirelessly receive the audio signal, to amplify the audio signal and to transmit the amplified audio signal to at least one speaker of at least one shared lighting and sound unit, the power amplifier being wirelessly communicatively coupled to the audio output device;
c) at least one low voltage power supply configured to provide a power signal to at least one lighting source of at least one shared lighting and sound unit, the low voltage power supply being coupled to the power amplifier and being wired to at least one lighting source of a shared lighting and sound unit.
d) a plurality of shared lighting and sound units mounted on a stake and each containing at least one lighting source configured to transmit light and at least one speaker configured to transmit sound, each shared lighting and sound unit being wired to a cable; and
e) at least one cable assembly configured to transmit at least the amplified audio signal and power signal, the cable assembly being wired to the power amplifier, to the low voltage power supply and to at least one of the plurality of shared lighting and sound units.
